(19) United States
(12) Patent Application Publication
(10) Pub. No.: US 2008/0270902 A1
(43) Pub. Date: Oct. 30, 2008

(54) Time Stamp Device

(76) Inventor: Kevin S. Sauerwald, Harleysville, PA (US)

Correspondence Address: Fleit Gibbons Gutman Bongini & Bianco P.L., 21355 E. Dixie Highway, Suite #115, Miami, FL, 33180, US

(21) Appl. No.: 11/741,036

(22) Filed: Apr. 27, 2007

(51) Int. Cl. G06F 3/00

(52) U.S. Cl. 715/710

(57) ABSTRACT

A time stamp device provides a timer for reminding a user how long ago or when an activity was last completed.

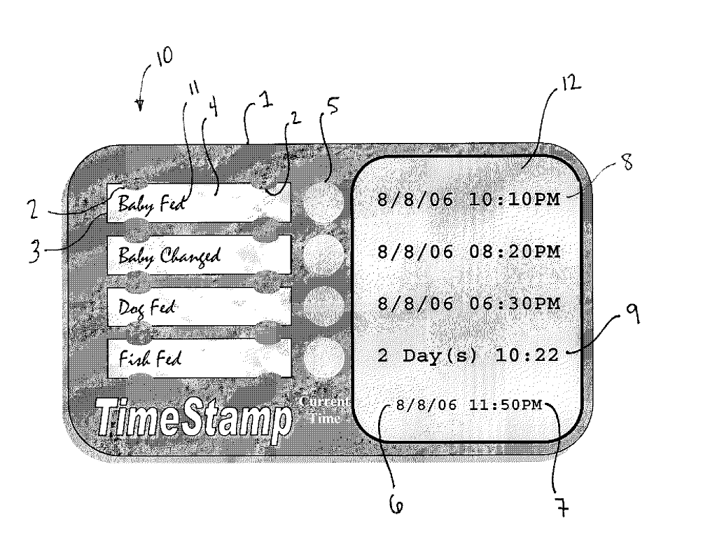

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to reminders that include date stamps.

2. Description of the Related Art

Ever wonder when something was last done? When you last fed the dog, fed the baby, took your medicine, or countless other things.

### BRIEF SUMMARY OF THE INVENTION

A time stamp device that overcomes the above-mentioned disadvantages of the heretofore-known devices of this general type reminds users when events occurred and how long ago an event occurred. The time stamp device reminds one when the last time something was done. Each time a task is done, the user simply presses a button to reset the timer so that they know when to conduct the task again.

It is accordingly an object of the invention to provide a device for tracking the completion (i.e. date and time) of many (for example, up to four) events with merely pushing a button.

It is a further object of the invention to provide a time stamp device that can be customized by the user to track a variety of events simultaneously. First, labels are completeable by a user to describe what event is being tracked.

The time stamp uses event labels for identifying the events being tracked. The event labels allow the user to customize what is being tracked.

An event trigger is triggered when the event occurs. Usually, the event trigger is manually operated by the user as closely as possible in time to the event being tracked.

The time stamp includes a display showing when the event trigger was pressed. The display can be a single display showing a plurality of events or a single display. The display can be switched between modes that show when the trigger was triggered or the time lapsed since the trigger was triggered.

The time stamp device can include a case to make a stand-alone unit that allows the entire time stamp device to be placed on a desktop or countertop.

Paper inserts which are seated in recesses in the case and held by tabs are a preferred form of event label. The paper inserts can be pre-printed with the names of events. Blank paper inserts can be included on which the user can write a customized label.

A button disposed on a case and connected to a microprocessor is a proffered form of an event trigger. The button can act to change the display mode (see below) as well.

The display can take the format of a clock. The display can show the entered time when the respective event occurred or an elapsed time since the entered time occurred. The display is housed in the claim. The display may be directly connected to the button or have a microprocessor interconnecting the button and the display.

Other features which are considered as characteristic for the invention are set forth in the appended claims.

Although the invention is illustrated and described herein as embodied in a time stamp device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The sole FIGURE is a top perspective view of the time stamp device.

### DETAILED DESCRIPTION OF THE INVENTION

Referring now to the sole FIGURE of the drawing in detail, there is seen a time stamp device generally marked by reference numeral 10. The time stamp device 10 includes a case 1. The case 1 preferably rests on a countertop or can be mounted to a wall. The case 1 houses the other components.

The case 1 includes a plurality of recesses 3. Each recess 3 holds a label which is preferably a paper label 4. An identifier 11 (i.e. the name of the event) is written or preprinted on the label 4.

The following is a list of possible tasks to be timed; Accordingly, preprinted labels for the activities can be included for the tasks: baby fed, baby changed, kids bath, kids went to potty, pet fed, cleaned/brushed pet, pet walked, checked pets water, pet potty break, medication taken, medical condition checked, plants watered, lawn watered, oil changed, tires rotated, tire pressure checked, wiper blades replaced, central air filter changed, fish tank cleaned, cat litter changed, pet washed, pet nails clipped, house vacuumed, sheets cleaned, smoke alarms checked, mattress flipped, checked grill propane, cleaned grill/oven, checked in with loved ones, paid the bills, septic pumped, septic treated, last time you had a cigarette (quitters), printed your digital photos, checked your printer ink, rebooted your computer, scanned for viruses, and scanned for spyware.

In an alternative embodiment, the label can be a digital display of a name.

A series of buttons 5 are disposed in the case 1. The buttons 1 are a preferred embodiment of a trigger for starting the timer associated with the button. The display 12 shows the timers. An event date 8 can be displayed that includes the date and time that the button 5 was pressed. The button 5 can be depressed for a period of time (e.g. three seconds), after which, the display shows elapsed time 9 since the button 5 was last pushed.

The display 12 includes the current date 6 and the current time 7.

I claim:

1. A time stamp device for tracking a time of an event, comprising:
an event label for identifying the event;
an event trigger to be pressed when the event occurs; and
a display showing when the event trigger was pressed.

2. A time stamp device for tracking an event, comprising:
a case for sitting on a desktop having a recess formed therein and a tab extending over said recess;
an insert inserted in said recess and being held by said tabs, said paper insert including an identifier identifying the event;
a button for setting an entered time when the respective event occurred disposed in said case; and
a display showing the entered time when the respective event occurred or an elapsed time since the entered time occurred, the display being disposed in said case and connected to said button.

3. A time stamp device for tracking a time of a plurality of events, comprising:
a case for sitting on a desktop having a respective recess for each of the events formed therein and a respective tab extending over said recess;
a paper insert for each respective event inserted in a respective one of said recesses and being held by a respective one of said tabs, said paper insert including a label identifying the respective event;
a button for each respective event setting an entered time when the respective event occurred disposed in said case;
a display for each respective event showing the entered time when the respective event occurred or an elapsed time since the entered time, the display disposed in said case and connected to said respective button; and
a clock disposed in said case for showing a current time.
